(19) United States
(12) Patent Application Publication
(10) Pub. No.: US 2021/0336917 A1
(43) Pub. Date: Oct. 28, 2021

(54) INFORMATION PROCESSING DEVICE AND NON-TRANSITORY COMPUTER READABLE MEDIUM

(71) Applicant: FUJIFILM BUSINESS INNOVATION CORP., Tokyo (JP)

(72) Inventor: Kengo TOKUCHI, Kanagawa (JP)

(73) Assignee: FUJIFILM BUSINESS INNOVATION CORP., Tokyo (JP)

(21) Appl. No.: 17/061,826

(22) Filed: Oct. 2, 2020

(30) Foreign Application Priority Data
Apr. 24, 2020 (JP) 2020-077241

(51) Int. Cl. H04L 12/58; G06F 3/0482; G06F 3/0484

(52) U.S. Cl. CPC H04L 51/32; H04L 51/04; G06F 3/0484; G06F 3/0482

(57) ABSTRACT

An information processing device includes a processor configured to cause a display device to display a display area for sharing content of a conversation that takes place among multiple posters who belong to a chat group. The multiple posters include a collective to which multiple individual users belong. The processor is further configured to cause the content of a statement by an individual user who belongs to the chat group to be displayed in the display area as the content of a statement by a collective to which the individual user posting the statement belongs.

### CROSS-REFERENCE TO RELATED APPLICATIONS

This application is based on and claims priority under 35 USC 119 from Japanese Patent Application No. 2020-077241 filed Apr. 24, 2020.

### BACKGROUND

### (i) Technical Field

The present disclosure relates to an information processing device and a non-transitory computer readable medium.

### (ii) Related Art

In some cases, a conversation takes places among multiple posters who belong to a chat group.

Japanese Unexamined Patent Application Publication No. 2004-240987 describes a chat provision system that manages chat topics divided into groups and controls an interface with a user terminal accessing the groups. In response to a request for a list of groups from the terminal, the chat provision system transmits a list of managed groups to the terminal, and in response to a request for information about a group from the terminal, the chat provision system transmits information about users in the group to the terminal.

Japanese Unexamined Patent Application Publication (Translation of PCT Application) No. 2002-524935 describes a video chat system in which a viewer is able to participate in real-time communication in a chat group with other viewers while watching television.

### SUMMARY

Aspects of non-limiting embodiments of the present disclosure relate to a display that exchanges statements made as a collective to which multiple individual users belong in a chat group.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to cause a display device to display a display area for sharing content of a conversation that takes place among multiple posters who belong to a chat group. The multiple posters include a collective to which multiple individual users belong. The processor is further configured to cause the content of a statement by an individual user who belongs to the chat group to be displayed in the display area as the content of a statement by a collective to which the individual user posting the statement belongs.

### BRIEF DESCRIPTION OF THE DRAWINGS

An exemplary embodiment of the present disclosure will be described in detail based on the following figures, wherein:

FIG. 1 is a block diagram illustrating a configuration of an information processing system according to an exemplary embodiment;

FIG. 2 is a block diagram illustrating a configuration of a social networking service (SNS) server according to the exemplary embodiment;

FIG. 3 is a block diagram illustrating a configuration of a terminal device according to the exemplary embodiment;

FIG. 4 is a diagram illustrating a collective management table;

FIG. 5 is a diagram illustrating a collective management table;

FIG. 6 is a diagram illustrating a collective management table;

FIG. 7 is a diagram illustrating a chat group management table;

FIG. 8 is a diagram illustrating a chat group management table;

FIG. 9 is a diagram illustrating a chat group management table;

FIG. 10 is a diagram illustrating a screen for a user K;

FIG. 11 is a diagram illustrating a screen for a user K;

FIG. 12 is a diagram illustrating a screen for a user K;

FIG. 13 is a diagram illustrating a screen for a user K;

FIG. 14 is a diagram illustrating a screen for a user K;

FIG. 15 is a diagram illustrating a screen for a user K;

FIG. 16 is a diagram illustrating a screen for a user K; and

FIG. 17 is a diagram illustrating a screen for a user K.

### DETAILED DESCRIPTION

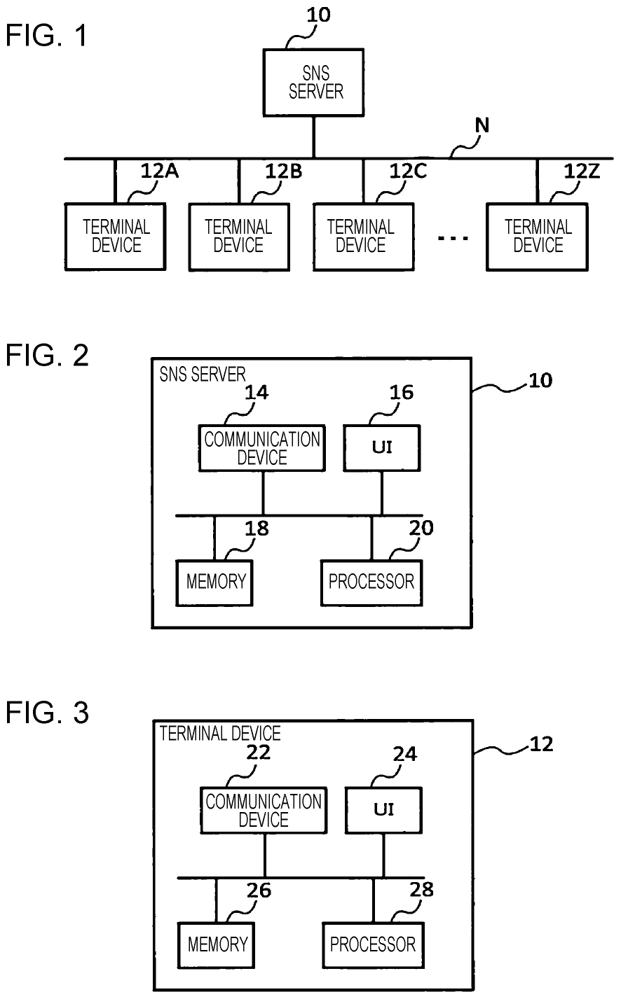

An information processing system according to the exemplary embodiment will be described with reference to FIG. 1. FIG. 1 illustrates an example of the configuration of the information processing system according to the exemplary embodiment.

The information processing system according to the exemplary embodiment includes an SNS server 10 and multiple terminal devices, for example. In the example illustrated in FIG. 1, the information processing system includes terminal devices 12A, 12B, 12C, . . . , 12Z. The number of terminal devices illustrated in FIG. 1 is merely an example, and it is sufficient for the information processing system to include multiple terminal devices. Hereinafter, the terminal devices 12A, 12B, 12C, . . . , 12Z will be referred to as the “terminal device(s) 12” when not being individually distinguished. In addition, the information processing system may also include device other than terminal devices (such as a server for example).

The SNS server 10 and the terminal devices 12 have a function of communicating with other devices. The communication may be wired communication using a cable, or wireless communication. In other words, the devices may transmit and receive information with each other through physical connection to other devices and the like using a cable, or transmit and receive information with each other through wireless communication. For the wireless communication, a technology such as short-range wireless communication or Wi-Fi (registered trademark) may be used, for example. Wireless communication according to a standard other than the above may also be used. The short-range wireless communication may be a technology such as Bluetooth (registered trademark), radio-frequency identifier (RFID), or near-field communication (NFC), for example. Each device may also communicate with another device through a communication channel such as a local area network (LAN) or the Internet. In the example illustrated in FIG. 1, the SNS server 10 and each of the terminal devices 12 is capable of communicating with other devices through a communication channel N. The communication channel N is the Internet, for example.

The SNS server 10 is a server that provides a social networking service (hereinafter referred to as an “SNS”). An SNS is a service that supports or promotes connections between a poster and other posters by supporting or promoting the exchange of information between posters who have joined the SNS. In some cases, an SNS does not allow a user to join unless the user is invited by an existing poster. Examples of an SNS include Facebook (registered trademark), LINE (registered trademark), Twitter (registered trademark), Instagram (registered trademark), and LinkedIn (registered trademark).

Information exchanged on an SNS may be text data such as messages and comments, image data (still image data and moving image data), sound data, or a combination of the above, for example. For example, on an SNS, actions such as transmitting, receiving, editing, and removing information may be enabled.

The SNS server 10 stores and manages user account information about posters who are registered members of the SNS. The user account information is information for logging in to and using the SNS, and for example is information including an SNS ID and a password. For example, by transmitting user account information to the SNS server 10 and logging in to the SNS, the poster possessing the user account information (that is, the poster to which the user account information is assigned) is allowed to use the SNS.

The SNS server 10 may also store and manage information indicating relationships between posters. The information indicating relationships between posters may be information indicating a level of trust between posters on the SNS, information indicating a type of relationship (such as friendship, for example) between posters, or information indicating both, for example.

A poster may be an individual user (in other words, a single user) or a collective to which multiple individual users belong. On the SNS, in some cases, a conversation takes place among multiple individual users, while in other cases, a conversation takes place among one or multiple individual users and one or multiple collectives, and in still other cases, a conversation takes place among multiple collectives.

A collective is any set of people, and may be a business unit such as a company, a department unit inside a business, a group unit inside a department, or a club unit such as an extracurricular activity. A collective may also be some other kind of set of persons, and is not limited by type or by the number of persons. A set of multiple individual users assembled for some purpose (for example, a team) may also be included in the concept of a collective.

Collectives may also be defined in a hierarchy. For example, a superordinate collective, an intermediate collective belonging to the superordinate collective, and a subordinate collective belonging to the intermediate collective may each be defined. For example, a baseball team and a soccer team may be subordinate collectives, and a sports collective to which the baseball team and the soccer team belong is a superordinate collective with respect to the baseball team and the soccer team. The definitions of a superordinate collective, an intermediate collective, and a subordinate collective are merely an example, and a hierarchy containing only a superordinate collective and a subordinate collective may also be defined, or a hierarchy broken down into even finer levels may also be defined.

Each terminal device 12 is a device such as a personal computer (hereinafter referred to as a “PC”), a tablet PC, a smartphone, or a mobile phone, for example. The terminal device 12 corresponds to one example of an information processing device. The terminal device 12 is used when a user uses the SNS. For example, when user account information for the SNS is set in the terminal device 12, the user account information is output to the SNS server 10, and the user logs in to the SNS.

In the exemplary embodiment, individual users A, B, C, . . . , Z each use their own terminal device 12. As an example, the terminal device 12A is used by the individual user A, the terminal device 12B is used by the individual user B, and the terminal device 12C is used by the individual user C. The same applies to the other individual users.

The user account information for each of the individual users A, B, C, . . . , Z is stored in the SNS server 10 and managed by the SNS server 10. In other words, the individual users A, B, C, . . . , Z are members of the SNS, registered in the SNS provided by the SNS server 10.

For example, the individual user A is able to log in to the SNS by operating the terminal device 12A, and use the SNS. The same applies to the individual users B, C, . . . , Z. Note that multiple individual users may also log in to the SNS by operating a single terminal device 12, and post information on the SNS by operating the single terminal device 12.

Additionally, the user account information of an automatic response agent such as a chatbot may also be managed by the SNS server 10, and the automatic response agent may also be a member of the SNS. For example, the automatic response agent functions as a virtual assistant that responds to user queries, and is configured to receive the content of a statement by a user on the SNS, analyze the content of the statement, create an answer or the like in response to the content of the statement, and notify the user on the SNS. The automatic response agent is achieved by executing a program, for example. The program is stored in the SNS server 10, another server, or the terminal device 12, for example. The automatic response agent may also be an automatic response AI achieved through artificial intelligence (AI). An algorithm of any type may be used for the artificial intelligence. Such an automatic response agent also corresponds to an example of a poster.

In the exemplary embodiment, one or more chat groups are created on the SNS. A chat group is a group in which information such as messages and images is exchanged among multiple posters belonging to the chat group. Information posted to a chat group is addressed to the posters belonging to the chat group. Note that a poster who is a member of the SNS may belong to multiple chat groups. Information posted to a chat group may also be edited, removed, or the like by a poster belonging to the chat group.

One or multiple individual users may belong to a chat group, and one or multiple collectives may belong to a chat group. For example, a conversation may take place among multiple individual users belonging to the same chat group, a conversation may take place among multiple collectives belonging to the same chat group, and a conversation may take place among one or multiple individual users and one or multiple collectives belonging to the same chat group.

The content of a statement that an individual user posts to a chat group may be posted as the content of a statement by the individual user, or may be posted as the content of a statement by a collective to which the individual user belongs. The statement type may be selected by the posting individual user or another individual user who has a right to make the selection, or the statement type may be determined in advance. For example, an individual user may post the content of a statement posted by the individual user as the content of a statement by a collective to which the individual user belongs, or as the content of a statement by the individual user. This process will be described in detail later.

Hereinafter, FIG. 2 will be referenced to describe a hardware configuration of the SNS server 10. FIG. 2 illustrates an example of the hardware configuration of the SNS server 10.

The SNS server 10 includes a communication device 14, a user interface (UI) 16, memory 18, and a processor 20, for example.

The communication device 14 is a communication interface including components such as a communication chip and a communication circuit, and has a function of transmitting information to another device and a function of receiving information transmitted from another device. The communication device 14 may have a wireless communication function, and may also have a wired communication function. The communication device 14 may communicate with another device by using short-range wireless communication for example, or communicate with another device through a communication channel such as a LAN or the Internet.

The UI 16 is a user interface, and includes a display device and an operation device. The display device is a device such as a liquid crystal display or an electroluminescence (EL) display. The operation device is a device such as a keyboard, one or more input keys, or a control panel. The UI 16 may be a UI such as a touch panel combining a display device with an operation device. In addition, a microphone may also be included in the UI 16, and a speaker that emits sound may also be included in the UI 16. Note that the UI 16 does not have to be provided in the SNS server 10.

The memory 18 is a device that establishes one or multiple storage areas that stores various types of information. For example, the memory 18 is a hard disk drive, any of various types of memory (such as RAM, DRAM, and ROM, for example), another type of storage device (such as an optical disc, for example), or a combination of the above. One or multiple memories 18 are included in the SNS server 10.

The memory 18 stores information such as the user account information of posters registered in the SNS and other information (such as management information for managing various information, for example). For example, information such as the user account information for individual users registered in the SNS, information related to collectives to which individual users belong, management information for managing individual users and collectives, management information for managing chat groups, and information indicating relationships between posters is stored in the memory 18. Note that user account information for a collective may also be created, and the user account information may be registered in the SNS and stored in the memory 18.

The processor 20 is configured to control the operation of each unit of the SNS server 10. For example, the processor 20 may communicate with each device using the communication device 14, cause the display device of the UI 16 to display information, receive information input through the UI 16, cause the memory 18 to store information, and read out information from the memory 18. The processor 20 may include memory.

Additionally, the processor 20 is configured to provide the SNS. For example, the processor 20 transmits information such as a message or an image posted on the SNS to a destination.

Also, the processor 20 is configured to manage chat groups. Managing chat groups refers to actions such as creating a chat group, dissolving a chat group, causing a new poster to belong a chat group, and removing a poster from a chat group.

For example, the processor 20 forms a chat group when a request to create a chat group is received from a poster who is a member of the SNS. In the case where a poster who does not belong to a chat group is attempting to join the chat group, if an approval is granted from one or more posters who belong to the chat group, the processor 20 may cause the poster who does not belong to the chat group to join and belong to the chat group. Additionally, the processor 20 may also exclude a poster from a chat group in response to an exclusion request from the poster who belongs to the chat group. Thereafter, the excluded poster is unable to exchange information in the chat group.

The processor 20 causes the memory 18 to store collective management information, which includes collective identification information for identifying a collective and individual user identification information for identifying each individual user who belongs to the collective in association with each other. By referencing the collective management information, an individual user who belongs to a collective may be specified. The collective identification information is information indicating a collective ID, a collective name, and the like. The individual user identification information is information such as user account information for the SNS and information for identifying the individual user on the SNS (such as a user ID, a real name, and a nickname or handle name, for example).

Note that the collective management information may be stored and managed in another server other than the SNS server 10, and may also be stored and managed in the terminal devices 12. In this case, the collective management information does not have to be stored in the SNS server 10.

Also, the processor 20 causes the memory 18 to store chat group management information, which includes chat group identification information for identifying a chat group and poster identification information for identifying each poster who belongs to the chat group in association with each other. By referencing the chat group management information, a poster who belongs to a chat group may be specified. The chat group identification information is information indicating a chat group ID, a chat group name, and the like. Information such as a task ID and a task name that indicate a specific task such as a conference performed by the chat group may also be one example of the chat group identification information. A poster is an individual user or a collective, and the poster identification information is individual user identification information or collective identification information.

Also, the processor 20 causes the memory 18 to store time information in association with the poster identification information, the time information indicating a time (for example, a date and time) at which a poster who belongs to the chat group started belonging to the chat group. By referencing the time information, the time at which a poster started belonging to a chat group may be specified. The processor 20 may also cause the memory 18 to store time information indicating a time when a poster withdrew from a chat group in association with the poster identification information.

For example, in the case where the individual user A who belongs to a chat group operates the terminal device 12A of the individual user A to post information such as a message or an image to the chat group as a statement by the individual user A, the posted information is transmitted from the terminal device 12A to the SNS server 10. The processor 20 of the SNS server 10 receives the posted information and transmits the posted information to the terminal device 12 of each other individual user who belongs to the chat group. For example, the posted information, the individual user identification information for the individual user A, information indicating that the posted information is information posted as a statement by the individual user A, and chat group identification information is transmitted from the terminal device 12A to the SNS server 10. The processor 20 specifies the poster identification information of posters (for example, individual users and collectives) other than the individual users A associated with the chat group identification information in the above chat group management information. The processor 20 transmits the information posted by the individual user A to the terminal device 12 of each other poster indicated by the specified poster identification information as a statement by the individual user A. In the case where the other poster is an individual user, the information posted by the individual user A is transmitted to the terminal device 12 of the individual user. In the case where the other poster is a collective, the information posted by the individual user A is transmitted to the terminal device 12 of each individual user who belongs to the collective. The information posted by the individual user A is displayed on each terminal device 12 as a statement by the individual user A. The same applies to information posted by other individual users besides the individual user A.

In the above example, in the case where the individual user A posts information such as a message or an image to a chat group as a statement by a collective to which the individual user A belongs, the posted information, the individual user identification information for the individual user A, the collective identification information for the collective to which the individual user A belongs, information indicating that the posted information is information posted as a statement by the collective, and the chat group identification information is transmitted from the terminal device 12A to the SNS server 10. The processor 20 specifies the poster identification information of posters (for example, individual users and collectives) other than the individual users A associated with the chat group identification information in the above chat group management information. The processor 20 transmits the information posted by the individual user A to the terminal device 12 of each other poster indicated by the specified poster identification information as a statement by the collective to which the individual user A belongs. In the case where the other poster is an individual user, the information posted by the individual user A is transmitted to the terminal device 12 of the individual user. In the case where the other poster is a collective, the information posted by the individual user A is transmitted to the terminal device 12 of each individual user who belongs to the collective. The information posted by the individual user A is displayed on each terminal device 12 as a statement by the collective to which the individual user A belongs. The same applies to information posted by other individual users besides the individual user A.

In addition, the processor 20 may also be configured to manage a history of posts to the SNS. For example, the processor 20 may manage a history of information that a poster posts to the SNS for each poster, or manage a history of information exchanged in a chat group for each chat group. History information indicating the history is stored in a location such as the memory 18 or another server.

Note that a program for achieving an automatic response agent may also be stored in the memory 18, and the processor 20 may execute the program. With this arrangement, posting to the SNS by the automatic response agent is achieved by the SNS server 10.

Hereinafter, FIG. 3 will be referenced to describe a hardware configuration of each terminal device 12. FIG. 3 illustrates an example of the hardware configuration of one of the terminal devices 12.

The terminal device 12 includes a communication device 22, a UI 24, memory 26, and a processor 28, for example.

The communication device 22 is a communication interface including components such as a communication chip and a communication circuit, and has a function of transmitting information to another device and a function of receiving information transmitted from another device. The communication device 22 may have a wireless communication function, and may also have a wired communication function. The communication device 22 may communicate with another device by using short-range wireless communication for example, or communicate with another device through a communication channel such as a LAN or the Internet.

The UI 24 is a user interface, and includes a display device and an operation device. The display device is a device such as a liquid crystal display or an electroluminescence (EL) display. The operation device is a device such as a keyboard, one or more input keys, or a control panel. The UI 24 may also be a UI such as a touch panel combining a display device with an operation device. In addition, a microphone may also be included in the UI 24, and a speaker that emits sound may also be included in the UI 24.

The memory 26 is a device that establishes one or multiple storage areas that stores various types of information. For example, the memory 26 is a hard disk drive, any of various types of memory (such as RAM, DRAM, and ROM, for example), another type of storage device (such as an optical disc, for example), or a combination of the above. One or multiple memories 26 are included in the terminal device 12.

For example, the memory 26 stores an SNS application program for using the SNS provided by the SNS server 10. By having the processor 28 execute the SNS application program, the SNS is usable on the terminal device 12.

Additionally, the memory 26 may also store information such as user account information for the SNS, collective identification information for a collective to which an individual user belongs, and individual user identification information for one or more other individual users who belong to the collective. For example, the memory 26 of the terminal device 12A may store information such as user account information for the individual user A, collective identification information for a collective to which the individual user A belongs, and individual user identification information for one or more other individual users who belong to the collective. Also, the memory 26 of each terminal device 12 may store the collective management information and the chat group management information described above.

The processor 28 is configured to control the operation of each component of the terminal device 12. For example, the processor 28 may communicate with each device using the communication device 22, cause the display device of the UI 24 to display information, receive information input through the UI 24, cause the memory 26 to store information, and read out information from the memory 26. The processor 28 may include memory.

Also, the processor 28 is configured to set user account information for the SNS according to an instruction from an individual user, and log in to the SNS by using the user account information. After logging in, the processor 28 posts information such as a message or an image to the SNS according to an instruction from the individual user. In the case where a chat group has been created, the processor 28 may also post information such as a message or an image to the chat group according to an instruction from the individual user.

The processor 28 is also configured to cause the display device of the UI 24 to display a display area for displaying information posted to the SNS. For example, in the case where a chat group has been created, the display area is for sharing the content of a conversation on the SNS among multiple posters who belong to the chat group.

Hereinafter, the information processing system according to the exemplary embodiment will be described in detail.

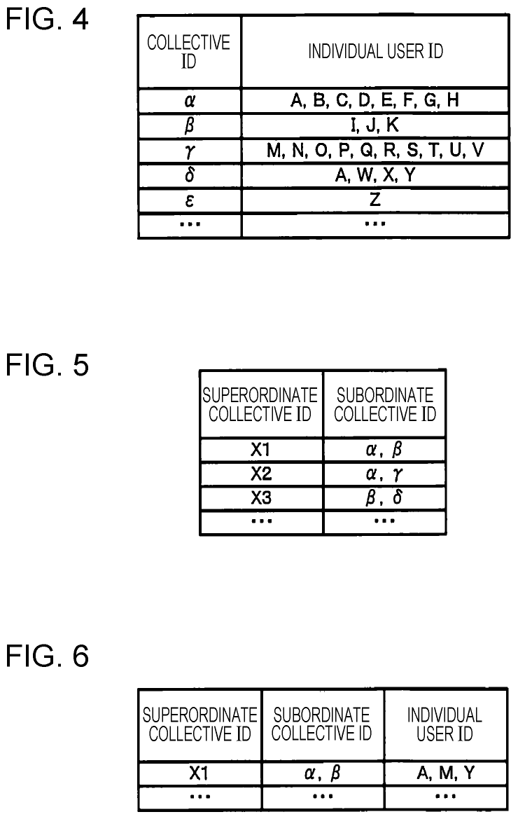

FIG. 4 will be referenced to describe the collective management information in detail. FIG. 4 illustrates an example of a collective management table as one example of the collective management information. The data of the collective management table is stored in the memory 18 of the SNS server 10. Obviously, the data may also be stored in a location such as the memory 26 of each terminal device 12 or in another server.

As illustrated in FIG. 4, in the collective management table, a collective ID for identifying a collective and one or more individual user IDs for identifying each individual user who belongs to the collective are associated with each other for each collective. The collective ID is an example of collective identification information. The individual user ID is an example of individual user identification information.

One or multiple individual users belong to a single collective. For example, the individual users A, B, C, D, E, F, G, and H belong to a collective α with the collective ID “α”. On the other hand, only the individual user Z belongs to a collective ε with the collective ID “ε”. Also, the same individual user may belong to multiple collectives. For example, the individual user A belongs to the collective α and a collective δ.

For example, if an individual user (such as an administrator, for example) who has a right to assign individual users to collectives uses the terminal device 12 to give an assignment instruction specifying a collective ID of the collective to belong to and the individual user ID of the individual user to assign to the collective, the collective ID and the individual user ID are transmitted from the terminal device 12 to the SNS server 10. The processor 20 of the SNS server 10 registers the collective ID and the individual user ID in association with each other in the collective management table. Additionally, the processor 20 may also exclude an individual user from a collective according to an instruction from a person such as an administrator who has a removal right.

FIG. 5 illustrates another collective management table. In this example, a hierarchy of collectives is defined. Specifically, a superordinate collective and subordinate collectives that belong to the superordinate collective are defined. For example, a subordinate collective α and a subordinate collective β belong to a superordinate collective X1 with a superordinate collective ID “X1”. One or multiple individual users belongs to each of the subordinate collectives α and β. For example, when described by taking a business such as a company as an example, the superordinate collective corresponds to a set referring to the business, while the subordinate collectives correspond to sets referring to departments in the business. For example, a subordinate collective may be made to belong to a superordinate collective by a person such as an administrator having an assignment right.

In the example illustrated in FIG. 5, superordinate collectives and subordinate collectives are defined, but a collective positioned in between the two (for example, an intermediate collective) may also be defined. In this case, one or multiple intermediate collectives belong to a superordinate collective, and one or multiple subordinate collectives belong to the intermediate collective. For example, the superordinate collective corresponds to a business, the one or more intermediate collectives correspond to departments within the company, and the one or more subordinate collectives correspond to sections or groups within a department. A hierarchy broken down into even finer levels may also be defined.

FIG. 6 illustrates yet another collective management table. In this example, a hierarchy of collectives is defined, and in addition, subordinate collectives and individual users separately belong to a superordinate collective. In the case where an individual user who belongs to the superordinate collective also belongs to a subordinate collective and the subordinate collective also belongs to the superordinate collective, the individual user belongs to the superordinate collective as an individual user while also belonging to the superordinate collective as a member of the subordinate collective. For example, the subordinate collectives α and β and the individual users A, M, and Y belong to the superordinate collective X1 with the superordinate collective ID “X1”. As illustrated in FIG. 4, because the individual user A also belongs to the subordinate collective α, the individual user A belongs to the superordinate collective X1 as an individual user while also belonging to the superordinate collective X1 as a member of the subordinate collective α.

The collective management tables illustrated in FIGS. 4, 5, and 6 are merely examples, and the data structure of each may also be different from the data structures illustrated in FIGS. 4, 5, and 6. For example, the collective management tables illustrated in each of FIGS. 4, 5, and 6 may also be integrated such that collectives and individual users belonging to the collectives are managed by a single collective management table.

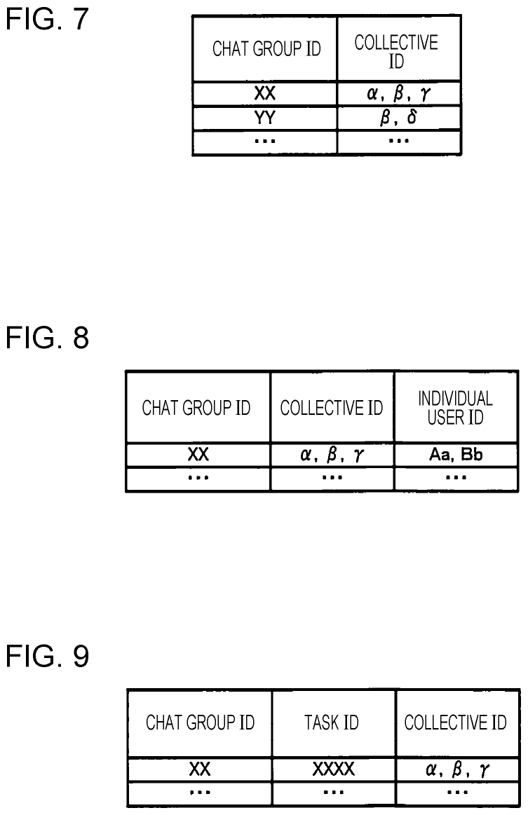

Hereinafter, FIG. 7 will be referenced to describe the chat group management information in detail. FIG. 7 illustrates an example of a chat group management table as one example of the chat group management information. The data of the chat group management table is stored in the memory 18 of the SNS server 10. Obviously, the data may also be stored in a location such as the memory 26 of each terminal device 12 or in another server.

As illustrated in FIG. 7, in the chat group management table, a chat group ID for identifying a chat group and one or more collective IDs for identifying each collective that belongs to the chat group are associated with each other for each chat group. The chat group ID is an example of chat group identification information.

One or multiple collectives belong to a single chat group. In other words, one or multiple collectives participate in a chat group. For example, collectives α, β, and γ belong to a chat group XX with the chat group ID “XX”. In other words, the collectives α, β, and γ participate in the same chat group XX. The individual users who belong to each of the collectives α, β, and γ participate in the chat group XX as members of the collective to which each individual user belongs. Obviously, the individual users who belong to each of the collectives α, β, and γ may also participate in the chat group XX as individuals rather than as members of a collective.

For example, in the case where the one or multiple individual users who belong to the collective α participate in the chat group XX as members of the collective α, the processor 20 of the SNS server 10 may manage the collective α as participating in the chat group XX. As a different example, in the case where a number of individual users equal to or greater than a predetermined number of individual users belonging to the collective α participate in the chat group XX as members of the collective α, the processor 20 may manage the collective α as participating in the chat group XX. The same applies to other collectives.

FIG. 8 illustrates another chat group management table. In this example, collectives and individual users separately belong to a chat group. For example, the collectives α, β, and γ and individual users Aa and Bb belong to the chat group XX. For example, the individual users who belong to each of the collectives α, β, and γ may participate in the chat group XX as members of the collective to which each individual user belongs, or participate in the chat group XX as individuals rather than members of a collective. The individual users Aa and Bb are individual users who do not belong to a collective, and are able to participate in the chat group XX as individuals. In this way, individual users who belong to a collective and individuals users who do not belong to a collective may participate in the same chat group.

FIG. 9 illustrates yet another chat group management table. In this example, a specific task such as a conference is set in a chat group, and the chat group ID, a task ID that acts as information for identifying the task, and one or more collective IDs of collectives participating in the task are associated with each other. Some or all of the collectives belonging to the chat group participate in the task that belongs to the chat group. In the example illustrated in FIG. 9, a task XXXX is set in the chat group XX, and the collectives α, β, and γ belong to the task XXXX. In other words, the collectives α, β, and γ participate in the task XXXX set in the chat group XX.

The chat group management tables illustrated in FIGS. 7, 8, and 9 are merely examples, and the data structure of each may also be different from the data structures illustrated in FIGS. 7, 8, and 9. For example, the chat group management tables illustrated in each of FIGS. 7, 8, and 9 may also be integrated such that collectives and individual users belonging to chat groups are managed by a single chat group management table.

Hereinafter, a specific example will be given to describe processes by the information processing system according to the exemplary embodiment in detail.

As an example, the collectives α, β, and γ and individual users belonging to each of these collectives are posters registered in the SNS. Each individual user may or may not be logged in to the SNS server 10. Also, the chat group XX to which the collectives α, β, and γ belong and the task XXXX belonging to the chat group XX are created. Hereinafter, information such as messages, image data, and sound data is assumed to be exchanged for the task XXXX.

For example, if the individual user A who belongs to the collective α operates the terminal device 12A to request the SNS server 10 to create the task XXXX belonging to the chat group XX, the processor 20 of the SNS server 10 creates the task XXXX to which the individual user A belongs on the SNS. Also, if the individual user A operates the terminal device 12A to give an instruction for inviting the collective α to the task XXXX, information indicating the instruction is transmitted from the terminal device 12A to the SNS server 10. The processor 20 of the SNS server 10 receives the information indicating the instruction, and causes the collective α to belong to the task XXXX. Note that a setting may also be set such that in the case where the individual user A belongs to the task XXXX, the collective α is also made to belong to the task XXXX automatically.

Also, if the individual user A operates the terminal device 12A to give an instruction for inviting the collectives β and γ to the task XXXX, information indicating the instruction is transmitted from the terminal device 12A to the SNS server 10. The processor 20 of the SNS server 10 receives the information indicating the instruction, and causes the collectives β and γ to belong to the task XXXX. Also, information indicating the invitation to the task XXXX may be sent to the individual users belonging to each of the invited collectives β and γ. In this case, if one or multiple individual users belonging to the collective β agree to participate in the task XXXX, if an individual user who belongs to the collective β and has a participation right agrees, or if a number of individual users equal to or greater than a predetermined number of individual users who belong to the collective β agree to participate, the processor 20 of the SNS server 10 may cause the collective β to belong to the task XXXX. The same applies to the collective γ.

As another example, if an individual user who belongs to the collective β operates the terminal device 12 to request the SNS server 10 to belong to the task XXXX, the processor 20 of the SNS server 10 may cause the collective β to belong to the task XXXX. The same applies to the collective γ.

In the case where an individual user makes a request to belong to the task XXXX, if the individual user who requested the creation of the task XXXX (for example, the individual user A) or one or multiple individual users who already belong to the task XXXX agree, the processor 20 of the SNS server 10 may cause the requesting individual user to belong to the task XXXX.

As yet another example, if the individual user A requests the SNS server 10 to create the task XXXX to which the collectives α, β, and γ belong, the processor 20 of the SNS server 10 may create the task XXXX to which the collectives α, β, and γ belong according to the request.

In the above examples, the individual user A creates the task XXXX, but another individual user may also create the task XXXX.

Also, if an individual user having a right to create a chat group or a task requests the SNS server 10 to create a chat group or a task, the processor 20 of the SNS server 10 may create the chat group or the task. Also, if an individual user having a right to invite other individual users or collectives to a chat group or a task requests the SNS server 10 to invite other individual users or collectives to a chat group or a task, the processor 20 of the SNS server 10 may cause the invited individual users or collectives to belong to the chat group or the task.

The processor 20 of the SNS server 10 manages the chat group XX and the task XXXX. Specifically, the processor 20 registers the chat group ID of the chat group XX, the task ID of the task XXXX, and collective ID of each of the collectives α and β that belong to the task XXXX in association with each other in the chat group management table (for example, the chat group management table illustrated in FIG. 9). The processor 20 may also register the user IDs of the individual users who belong to each of the collectives α and β to the chat group management table. Obviously, the processor 20 may also manage the chat group XX and the task XXXX without using such a management table. In addition, the processor 20 may also register date and time information indicating the time (for example, the date and time) at which each individual user and each collective started belonging to the task XXXX in the chat group management table.

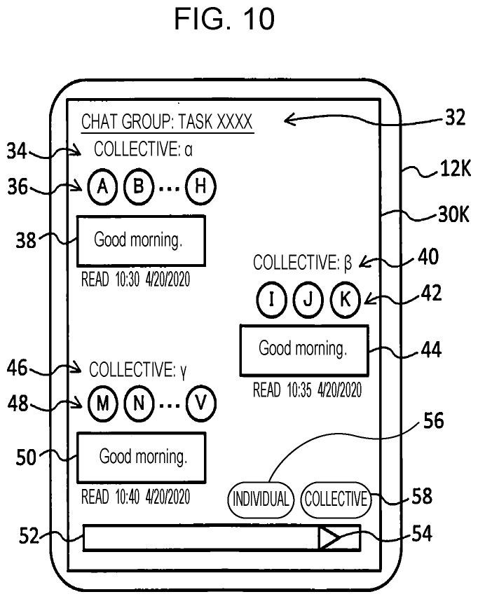

FIG. 10 illustrates an example of a screen displayed when exchanging information among posters participating in the task XXXX in the chat group XX. A screen 30K illustrated in FIG. 10 is a chat screen displayed on the display device of the UI 24 of the terminal device 12K used by the individual user K who belongs to the collective β participating in the task XXXX. The processor 28 of the terminal device 12K causes the display device of the UI 24 to display the screen 30K. The screen 30K corresponds to an example of a display area where multiple posters share the content of a conversation that takes place among multiple posters participating in the task XXXX in the chat group XX. On the screen 30K, information (for example, a character string such as a message, image data, sound data, or the like) that each individual user has posted as a statement by the individual user and information that each individual user has posted as a statement by the collective to which the individual user belongs is displayed. Here, the conversation for the task XXXX is a conversation in a chat format as an example. Specifically, the format of the conversation is a format in which the conversation proceeds as the posters (that is, the individual users or collectives) participating in the task XXXX transmit information to each other.

For example, if the individual user K operates the terminal device 12K to give an instruction to launch the SNS application program, the processor 28 of the terminal device 12K causes the display device of the UI 24 of the terminal device 12K to display a screen for the SNS (such as a menu screen for example). If the individual user K makes a request to participate in the task XXXX, the screen 30K illustrated in FIG. 10 is displayed by the display device of the UI 24 of the terminal device 12K.

The processor 28 of the terminal device 12K displays information such as messages posted to the task XXXX on the screen 30K. For example, the processor 28 of the terminal device 12K displays information such as a message that the individual user K has posted as a statement by the individual user K and a message that the individual user K has posted as a statement by the collective β on the screen 30K. Additionally, the processor 28 of the terminal device 12K receives information such as messages posted to the task XXXX by other individual users and other collectives through the SNS server 10, and displays the received messages and the like on the screen 30K. For example, the processor 28 of the terminal device 12K displays each message or the like posted to the task XXXX on the screen 30K arranged in chronological order according to the date and time of the post. As the conversation proceeds on the screen 30K, the processor 28 causes the screen 30K to scroll to display the most recent message or the like on the screen 30K.

As the sign 32 points out, a character string (such as “Task XXXX” for example) indicating the name of the task that is the subject of the conversation may also be displayed on the screen 30K.

The processor 28 of the terminal device 12K displays collective identification information for identifying each collective participating in the task XXXX and individual user identification information for identifying each individual user belonging to each collective on the screen 30K.

For example, the processor 28 of the terminal device 12K displays the content of a statement that an individual user has posted as a statement by the individual user in association with the individual user identification information for that individual user on the screen 30K. Also, the processor 28 of the terminal device 12K displays the content of a statement that an individual user has posted as a statement by a collective to which the individual user belongs in association with the collective identification information for that collective on the screen 30K. With respect to the content of a statement by a collective, the processor 28 of the terminal device 12K may associate the individual user identification information for each individual user belonging to the collective, or associate the individual user identification information for the individual user who posted the statement.

The associated individual user identification information is information such as an image expressing the individual user, a character string for identifying the individual user (such as a real name, an individual user ID, a handle name, or a nickname, for example), or a combination of an image and a character string, for example.

The associated collective identification information is information such as an image expressing the collective, a character string for identifying the collective (such as a collective name, an collective ID, a handle name, or a nickname, for example), or a combination of an image and a character string, for example.

For example, on the screen 30K displayed on the terminal device 12K used by the individual user K, the content of statements such as messages posted as statements by the individual user K and the content of statements such as messages posted as statements by the collective β to which the individual user K belongs are displayed in the area on the right side. The content of statements posted by individual users belonging to a collective other than the collective β (for example, the collectives α and γ) as statements by the individual users and the content of statements posted as statements by the collectives α and γ are displayed in the area on the left side. This display format is merely one example, and a different display format may also be adopted. For example, messages posted by each user may also be displayed with vertical separation, and may also be displayed in the same area.

In the example illustrated in FIG. 10, as the sign 34 points out, a character string indicating the collective α is displayed on the screen 30K. Also, as the sign 36 points out, images of the individual users who belong to the collective α (for example, an image of each of the individual users A, B, . . . , H) are displayed on the screen 30K. A message 38 is a message posted as a statement by the collective α, and a character string indicating the collective α and images of the individual users who belong to the collective α are displayed in association with the message 38. For example, the images of the individual users are displayed above the message 38, and the character string indicating the collective α is displayed above the images of the individual users. The same applies to other messages. Note that this display format is merely one example, and information such as messages, images, and character strings may also be displayed according to another display format.

Also, as the sign 40 points out, a character string indicating the collective β is displayed on the screen 30K. Also, as the sign 42 points out, images of the individual users who belong to the collective β (for example, an image of each of the individual users I, J, and K) are displayed on the screen 30K. A message 44 is a message posted as a statement by the collective β, and a character string indicating the collective β and images of the individual users who belong to the collective β are displayed in association with the message 44.

Also, as the sign 46 points out, a character string indicating the collective γ is displayed on the screen 30K. Also, as the sign 48 points out, images of the individual users who belong to the collective γ (for example, an image of each of the individual users M, N, . . . , V) are displayed on the screen 30K. A message 50 is a message posted as a statement by the collective γ, and a character string indicating the collective γ and images of the individual users who belong to the collective γ are displayed in association with the message 50.

Note that in the case where the images of the individual users do not fit in the display area side by side, some of the images of the individual users may also not be displayed, or some or all of the images of the individual users may be displayed overlapping each other. For example, the individual users A, B, . . . , H belong to the collective α, but because the images for all of the individual users A, B, . . . , H do not fit in the display area, only some of the images of the individual users are displayed, as the sign 36 points out. The same applies to other collectives.

Also, on the screen 30K, an input field 52 and a transmit button 54 are displayed. If a message is input into the input field 52 and the transmit button 54 is pressed, the processor 28 of the terminal device 12K posts the message to the task XXXX. A button or field for selecting image data or sound data may also be displayed on the screen 30K, and image data or sound data selected thereby may also be posted.

Additionally, a button 56 for posting a statement such as a message as a statement by an individual user and a button 58 for posting the statement as a statement by a collective to which the individual user belongs are displayed on the screen 30K. The button 56 is a button for choosing to post a statement from an individual user as a statement by the individual user. The button 58 is a button for choosing to post a statement from an individual user as a statement by a collective to which the individual user belongs.

For example, if the individual user K inputs a message into the input field 52, presses the button 56, and presses the transmit button 54, the processor 28 of the terminal device 12K posts the message to the task XXXX as a statement by the individual user K. The message is displayed as a statement by the individual user K.

Also, if the individual user K inputs a message into the input field 52, presses the button 58, and presses the transmit button 54, the processor 28 of the terminal device 12K posts the message to the task XXXX as a statement by the collective β to which the individual user K belongs. The message is displayed as a statement by the collective β.

Note that in the case where the transmit button 54 is pressed without pressing either of the buttons 56 and 58, a message input into the input field 52 may be posted as a statement by the individual user K or as a statement by the collective β. As another example, it may be configured such that unless one of the buttons 56 and 58 is pressed, a message is not posted even if the transmit button 54 is pressed.

For example, in the case where the transmit button 54 is pressed without specifying a collective before posting a statement such as a message (for example, in the case where the transmit button 54 is pressed without pressing the button 58), the processor 28 of the terminal device 12K may post the content of the statement such as a message as the content of a statement by the individual user K. In this case, even if the button 56 is not pressed, the processor 28 of the terminal device 12K posts the content of the statement such as a message as a statement by the individual user K.

As another example, in the case where the transmit button 54 is pressed without specifying an individual user before posting a statement such as a message (for example, in the case where the transmit button 54 is pressed without pressing the button 56), the processor 28 of the terminal device 12K may post the content of the statement such as a message as the content of a statement by the collective β. In this case, even if the button 58 is not pressed, the processor 28 of the terminal device 12K posts the content of the statement such as a message as a statement by the collective β.

Screens similar to the screen 30K are also displayed on the terminal devices 12 used by the other individual users besides the individual user K. The content of statements posted by an individual user as statements by the individual user and the content of statements posted as statements by a collective to which the individual user belongs are displayed in the area on the right side, while the content of statements by other collectives and the content of statements by individual users belonging to other collectives are displayed in the area on the left side.

Hereinafter, the screen 30K for the task XXXX displayed on the display device of the UI 24 of the terminal device 12K of the user K may be referred to as the “screen 30K for the user K”. The same applies to the screen for the task XXXX displayed on the other terminal devices 12.

In the example illustrated in FIG. 10, a message 38 by the collective α, a message 44 by the collective β, and a message 50 by the collective γ are posted in order, and these messages are displayed on the screen 30K chronologically. The message 38 is posted as a statement by the collective α, the message 44 is posted as a statement by the collective β, and the message 50 is posted as a statement by the collective γ.

Note that in the case where a message is posted as a statement by an individual user rather than as a statement by a collective, an image of the individual user may be displayed in association with the message, and the collective identification information of the collective to which the individual user belongs does not have to be displayed. For example, in the case where the message 44 is posted as a statement by the individual user K rather than as a statement by the collective β, an image of the individual user K is displayed in association with the message 44, whereas the images of the other individual users (for example, the individual users I and J) who belong to the collective β and the collective identification information of the collective β are not displayed in association with the message 44.

Each message illustrated in FIG. 10 is transmitted to the terminal device 12 of each individual user who belongs to the task XXXX through the SNS server 10. For example, if the individual user A operates the terminal device 12A to post the message 38 as the content of a statement by the collective α, the message 38, the individual user identification information of the individual user A who posted the message 38, the collective identification information of the collective α to which the individual user A belongs, information indicating that the posted message 38 has been posted as a statement by the collective α, the chat group identification information of the chat group XX, and the task ID indicating the task XXXX are transmitted from the terminal device 12A to the SNS server 10. The processor 20 of the SNS server 10 specifies the poster identification information (for example, collective IDs and individual user IDs) associated with the task in the chat group management table illustrated in FIG. 9 for example, and specifies the individual user IDs associated with each collective ID by referencing the collective management table illustrated in FIG. 4 for example. Next, the processor 20 of the SNS server 10 transmits the message 38 posted by the individual user A as a statement by the collective α to the terminal device 12 of each individual user indicated by each specified individual user ID. The message 38 is displayed as a statement by the collective α on the display device of the UI 24 of the terminal device 12 of each individual user. For example, as illustrated in FIG. 10, the message 38 is displayed on the screen 30K for the individual user K, and furthermore, as the sign 34 points out, the collective identification information of the collective α is displayed in association with the message 38, and as the sign 36 points out, images of the individual users who belong to the collective α are displayed in association with the message 38. The same applies to messages posted by other individual users.

Note that in the case where the message 38 is posted as a statement by the individual user A, information indicating that the posted message 38 is posted as a statement by the individual user A is transmitted from the terminal device 12A to the SNS server 10 instead of the information indicating that the posted message 38 is posted as a statement by the collective α. Thereafter, the message 38 is transmitted to and displayed on the terminal device 12 of each individual user as a statement by the individual user A.

The messages 38, 44, and 50 are displayed in chronological order according to the date and time when each message was posted, arranged from the top to the bottom of the screen 30K. Among the messages 38, 44, and 50, the message 38 is the oldest message, and the message 50 is newest message. Note that in the case where information such as image data or sound data is posted, information such as a thumbnail image associated with the image data or the sound data may also be displayed on the screen 30K.

Note that by causing the screen 30K to scroll, messages posted earlier than the point in time at which the message 38 was posted may also be displayed.

Note that information indicating the date and time when a message was posted may also be displayed in association with the message. For example, the message 38 was posted at 10:30 am on Apr. 20, 2020, and a character string indicating the date and time is displayed on the screen 30K in association with the message 38. For example, the character string indicating the date and time is displayed near the display position of the message 38 (such as below the message 38). The same applies to other messages. Also, a mark (for example, a “Read” mark) indicating that a message has been read by another individual user may be displayed in association with the message, and the number of individual users that have read the message may also be displayed in association with the message.

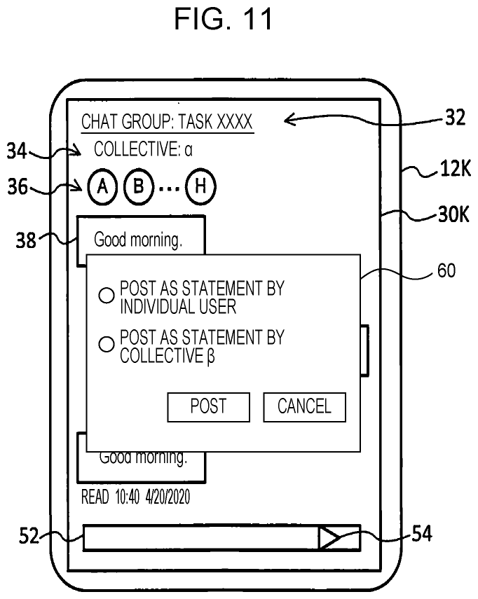

FIG. 11 illustrates another example of the screen 30K. For example, if a message is input into the input field 52 and the transmit button 54 is pressed, the processor 28 of the terminal device 12K causes the display device of the UI 24 of the terminal device 12K to display a selection screen 60. In the example illustrated in FIG. 11, the selection screen 60 is displayed inside the screen 30K.

The selection screen 60 is a screen for selecting whether to post a statement such as a message as a statement by an individual user or as a statement by a collective. Because the individual user K belongs to the collective β, the name or ID of the collective β is displayed on the selection screen 60.

For example, if the individual user K chooses to post a statement such as a message as a statement by the individual user and presses a button for posting on the selection screen 60, the processor 28 of the terminal device 12K posts the message input into the input field 52 as a statement by the individual user K.

If the individual user K chooses to post a statement such as a message as a statement by the collective β and presses the button for posting on the selection screen 60, the processor 28 of the terminal device 12K posts the message input into the input field 52 as a statement by the collective β.

Note that the selection screen 60 may also be displayed when the transmit button 54 is pressed, irrespectively of whether or not a message is input into the input field 52. In this case, if the option to post a statement by an individual user or the option to post a statement a statement by a collective is selected on the selection screen 60, and then a message is input into the input field 52 and the transmit button 54 is pressed, the message is posted according to the selection. As another example, a button for displaying the selection screen 60 may be displayed on the screen 30K, and if the button is pressed, the selection screen 60 may be displayed.

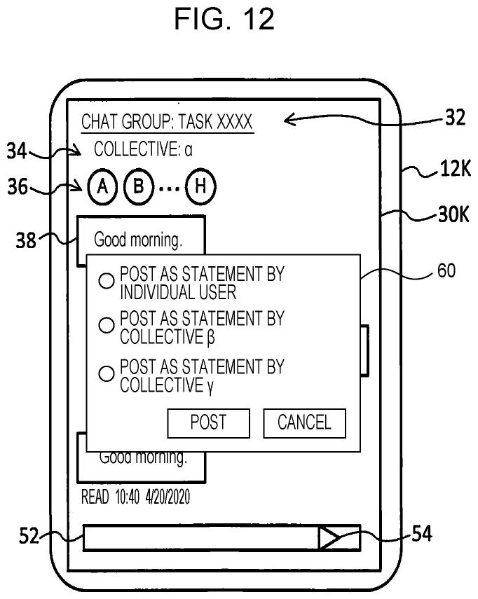

FIG. 12 illustrates yet another example of the screen 30K. Here, as an example, it is assumed that the individual user K belongs to multiple collectives (for example, the collectives β and γ). In this case, the names or IDs of the multiple collectives are displayed on the selection screen 60. At this point, because the individual user K belongs to the collectives β and γ, the selection screen 60 is a screen for selecting whether to post a statement such as a message as a statement by the individual user, as a statement by the collective β, or as a statement by the collective γ. The selection screen 60 may also enable the individual user K to select whether to post a statement such as a message as a statement by some or all of the multiple collectives to which the individual user K belongs. For example, it may be possible to select whether to post a statement by the individual user K as a statement by both the collectives β and γ. The flow of processes after selecting is the same as the flow of processes described with reference to FIG. 11. For example, in the case of choosing to post a statement such as a message as a statement by the collective γ, the message posted by the individual user K is posted and displayed as a statement by the collective γ.

The processor 28 of the terminal device 12K may also display, on the screen 30K, the individual user identification information of the individual user who posted a statement as a statement by a collective differently from the individual user identification information of another individual user who belongs to the collective. For example, the processor 28 of the terminal device 12K may change the display position of the individual user identification information, change the display color of the individual user identification information, change the display size of the individual user identification information, cause the individual user identification information to blink, change the display format of the individual user identification information, or alter the individual user identification information.

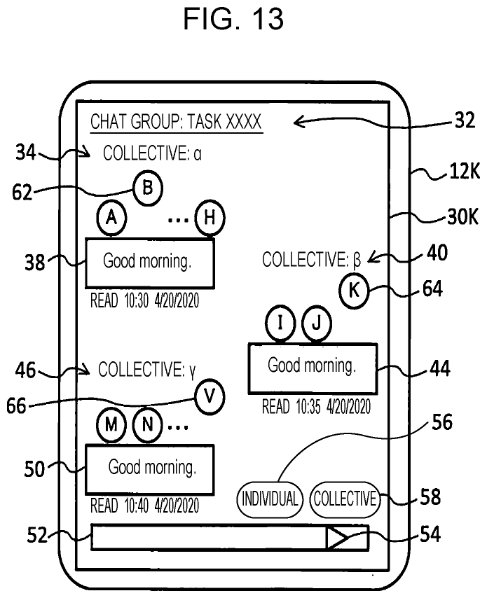

FIG. 13 illustrates an example of displaying individual user identification information differently. For example, the message 38, which is a statement by the collective α, is a message posted by the individual user B who belongs to the collective α. The individual user identification information of the individual user B who posted the message 38 is transmitted from the terminal device 12B used by the individual user B to the terminal device 12 of each individual user through the SNS server 10, and therefore each terminal device 12 is capable of specifying the individual user who posted the message 38. For example, the processor 28 of the terminal device terminal device 12K displays an image 62 of the individual user B at a different position from the images of the other individual users who belong to the collective α. In the example illustrated in FIG. 13, the image 62 of the individual user B is displayed higher than the images of the other individual users who belong to the collective α. The display position may also be a position such as lower rather than higher. In other words, the processor 28 of the terminal device 12K changes the display position of the image 62 of the individual user B from the display position of the image 62 of the individual user B in the case where the individual user B has not posted a statement as a statement by the collective α, and displays the image 62 at the changed display position on the screen 30K. The image of the individual user B is also displayed similarly on the other terminal devices 12.

Additionally, the message 44, which is a statement by the collective β, is a message posted by the individual user K who belongs to the collective β. Like the image 62 of the individual user B, an image 64 of the individual user K is displayed higher than the images of the other individual users who belong to the collective β. In other words, the image 64 of the individual user K is changed from the display position of the image 64 in the case where the individual user K has not posted a statement as a statement by the collective β, and the image 64 is displayed at the changed display position on the screen 30K.

Additionally, the message 50, which is a statement by the collective γ, is a message posted by the individual user V who belongs to the collective γ. Like the image 62 of the individual user B, an image 66 of the individual user V is displayed higher than the images of the other individual users who belong to the collective γ. In other words, the image 66 of the individual user K is changed from the display position of the image 66 in the case where the individual user V has not posted a statement as a statement by the collective γ, and the image 66 is displayed at the changed display position on the screen 30K.

As a different example, properties such as the display color, display size, or format of the image of an individual user who posted a message (for example, the image of each of the individual users B, K, and V) may be different from the images of the individual users who did not post the message. Also, the image of an individual user who has posted a message may also be made to blink or may be altered for display.

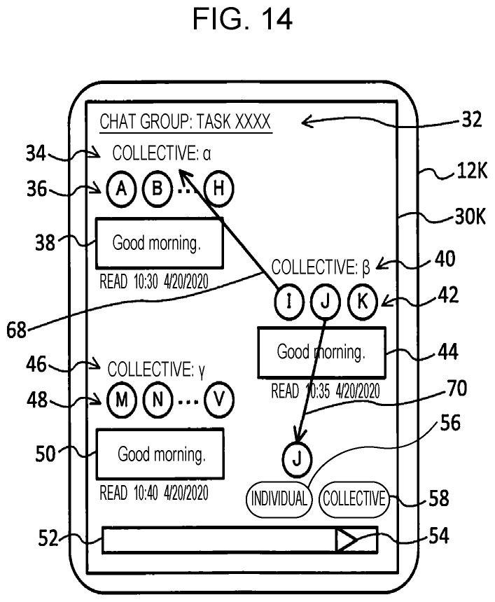

On the screen for the SNS, operating the individual user identification information of an individual user may also cause the individual user to belong to a collective to which the individual user does not belong. For example, in the case where an operation of associating the individual user of an individual user with a collective to which the individual user does not belong is performed on the screen for the SNS, the processor 28 of the terminal device 12 causes the individual user subjected to the operation to belong to the collective subjected to the operation. In this case, the processor 28 of the terminal device 12 transmits the individual user identification information of the individual user subjected to the operation, the collective identification information of the collective subjected to the operation, and information indicating a request to make the individual user belong to the collective to the SNS server 10. The processor 20 of the SNS server 10 receives the information indicating the request, and registers the individual user identification information and the collective identification information in association with each other in the collective management information. With this arrangement, the individual user subjected to the operation is made to belong to the collective subjected to the operation. The individual user who is able to make an individual user belong to a collective may be an individual user who has a right to assign individual users to collectives, an individual user who belongs to the same collective as the individual user subjected to the operation, an individual user who belongs to the destination collective, or the individual user him- or herself subjected to the operation. Also, the individual user subjected to the operation may also be allowed to belong to a collective in the case where an individual user who belongs to the destination collective (for example, an individual user having a right to allow new users into the collective) allows the individual user to belong to the collective, or in the case where a number of individual users equal to or greater than a predetermined number of individual users who belong to the destination collective allow the individual user to belong to the collective. Hereinafter, this process will be described in detail with reference to FIG. 14. FIG. 14 illustrates the screen 30K for the individual user K.

For example, on the screen 30K, if the individual user K operates the image of the individual user I who belongs to the same collective β as the individual user K, and as the arrow 68 points out, moves the image of the individual user I to a display position assigned to the collective α (for example, the display position of the collective identification information of the collective α, the display position of the images of the individual users who belong to the collective α, or the display position of the message 38 by the collective α), the individual user I is made to belong to the collective α. In this case, the processor 28 of the terminal device 12K transmits the individual user identification information (for example, the individual user ID) of the individual user I, the collective identification information (for example, the collective ID) of the collective α, and information indicating a request to make the individual user I belong to the collective α to the SNS server 10. The processor 20 of the SNS server 10 receives the information indicating the request, associates the individual user ID of the individual user I with the collective ID of the collective α, and registers the associated information in the collective management table illustrated in FIG. 4 for example. Additionally, the information indicating the request may also be transmitted from the terminal device 12K through the SNS server 10 to the terminal device 12 of each individual user who belongs to the collective α or to the terminal device 12 of an individual user who belongs to the collective α and has a right to allow new users into the collective α. Thereafter, if the individual user I is allowed to belong to the collective α by the individual user who has the right or by a number of individual users equal to or greater than a predetermined number of individual users who belong to the collective α, the processor 20 of the SNS server 10 may cause the individual user I to belong to the collective α.

In the case where the individual user K is the individual user who has the right, the individual user K may be allowed to cause another individual user who belongs to the collective β to belong to another collective. As another example, an individual user may be allowed to operate only his or her own image to cause him- or herself to belong to a collective. Additionally, an individual user may also be allowed to cause an individual user who belongs to another collective to belong to his or her own collective.

As an operation other than an operation of moving the image of an individual user, an individual user may also be made to belong to a collective by specifying the image of the individual user and the collective identification information of the collective to which the individual user is to belong on the screen 30K, for example. For example, an individual user may be made to belong to a collective in the case where a long press (for example, a press that is performed for a predetermined duration or longer) is performed on the image of the individual user or on the collective identification information of the collective.

On the screen for the SNS, operating the individual user identification information of an individual user may also exclude the individual user from a collective to which the individual user belongs. For example, in the case where an operation is performed to transfer the individual user identification information of an individual user from the display position of the individual user identification information of the individual user to another position on the screen for the SNS, the processor 28 of the terminal device 12 excludes the individual user subjected to the operation from the collective subjected to the operation. In this case, the processor 28 of the terminal device 12 transmits the individual user identification information of the individual user subjected to the operation, the collective identification information of the collective subjected to the operation, and information indicating a request to exclude the individual user from the collective to the SNS server 10. The processor 20 of the SNS server 10 receives the information indicating the request, and dissolves the association between the individual user identification information and the collective identification information. For example, the processor 20 of the SNS server 10 removes the individual user identification information associated with the collective identification information in the collective management information. With this arrangement, the individual user subjected to the operation is excluded from the collective subjected to the operation. The individual user who is able to exclude an individual user from a collective may be an individual user who has a right to exclude individual users from collectives, an individual user who belongs to the same collective as the individual user subjected to the operation, or the individual user him- or herself subjected to the operation. Also, the individual user subjected to the operation may also be allowed to be excluded from a collective in the case where an individual user who belongs to the collective (for example, an individual user having a right to exclude users from the collective) allows the individual user to be excluded from the collective, or in the case where a number of individual users equal to or greater than a predetermined number of individual users who belong to the collective allow the individual user to be excluded from the collective. Hereinafter, this process will be described in detail with reference to FIG. 14.

For example, on the screen 30K, if the individual user K operates the image of the individual user J who belongs to the same collective β as the individual user K, and as the arrow 70 points out, moves the image of the individual user J to a region outside the display position assigned to the collective β (for example, the display position of the collective identification information of the collective β, the display position of the images of the individual users who belong to the collective β, or the display position of the message 44 by the collective β), the individual user J is excluded from the collective β. In this case, the processor 28 of the terminal device 12K transmits the individual user identification information (for example, the individual user ID) of the individual user J, the collective identification information (for example, the collective ID) of the collective β, and information indicating a request to exclude the individual user J from the collective β to the SNS server 10. The processor 20 of the SNS server 10 receives the information indicating the request, and dissolves the association between the individual user ID of the individual user J and the collective ID of the collective β. For example, the processor 20 removes the individual user ID of the individual user J associated with the collective ID of the collective β in the collective management table illustrated in FIG. 4. As another example, the processor 20 may also associate information such as a flag indicating that the individual user J is excluded from the collective β with the collective ID of the collective β, without removing the individual user ID of the individual user J. Additionally, the information indicating the request may also be transmitted from the terminal device 12K through the SNS server 10 to the terminal device 12 of each individual user who belongs to the collective β or to the terminal device 12 of an individual user who belongs to the collective β and has a right to exclude users from the collective β. Thereafter, if the individual user J is allowed to be excluded from the collective β by the individual user who has the right or by a number of individual users equal to or greater than a predetermined number of individual users who belong to the collective β, the processor 20 of the SNS server 10 excludes the individual user J from the collective β.

In the case where the individual user K is the individual user who has the right, the individual user K may be allowed to exclude another individual user who belongs to the collective β from the collective β. As another example, an individual user may be allowed to operate only his or her own image to exclude him- or herself from a collective.

As an operation other than an operation of moving the image of an individual user, an individual user may also be excluded from a collective by specifying the image of the individual user and the collective identification information of the collective from which the individual user is to be excluded on the screen 30K, for example. For example, an individual user may be excluded from a collective in the case where a long press (for example, a press that is performed for a predetermined duration or longer) is performed on the image of the individual user or on the collective identification information of the collective.

Note that an excluded individual user may be excluded from only a task to which the individual user belongs or from only a chat group to which the individual user belongs, without being excluded from the collective itself to which the individual user belongs.

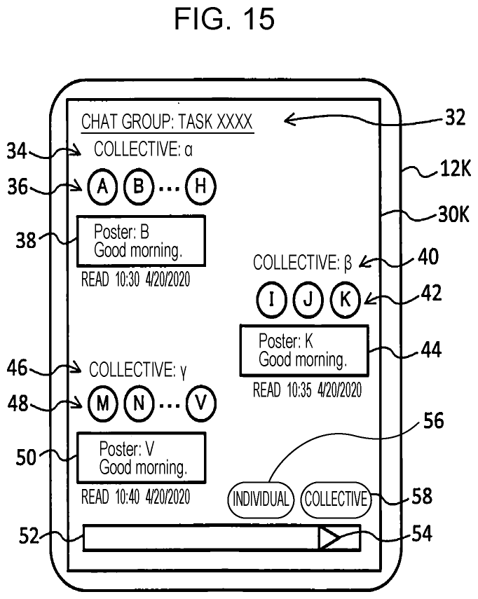

The processor 28 of the terminal device 12K may also display the individual user identification information of an individual user who has posted a statement inside an area where the content of the statement is displayed. Hereinafter, this process will be described with reference to FIG. 15. The screen 30K is illustrated in FIG. 15.

For example, the processor 28 of the terminal device 12K displays the individual user identification information (such as the individual user ID, a real name, or a nickname, for example) of the individual user B who posted the message 38 inside the display area of the message 38 (for example, inside a message box in which the message 38 is displayed). Similarly, the individual user identification information of the individual user K who posted the message 44 is displayed inside the display area of the message 44, and the individual user identification information of the individual user V who posted the message 50 is displayed inside the display area of the message 50.

In the example illustrated in FIG. 15, the individual user identification information is displayed above the message, but the individual user identification information may also be displayed below, to the left, or to the right of the message, for example. In addition, the display format of the individual user identification information may also be a format such as “ . . . by (individual user identification information)”. For example, a character string such as “ . . . by B” may be displayed in the display area of a message posted by the individual user B.

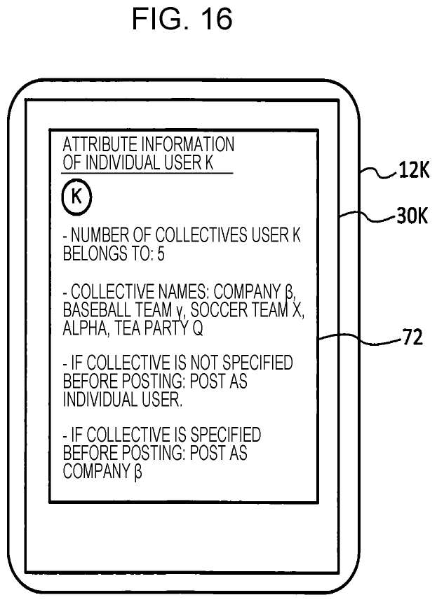

Hereinafter, FIG. 16 will be referenced to describe attribute information of an individual user. Here, the attribute information of the individual user K will be described as an example. The screen 30K is illustrated in FIG. 16.

For example, if the individual user K operates the terminal device 12K to give an instruction to display the attribute information, the processor 28 of the terminal device 12K causes the display device of the UI 24 of the terminal device 12K to display an attribute display screen 72. In the example illustrated in FIG. 16, the attribute display screen 72 is displayed inside the screen 30K.

On the attribute display screen 72, information such as information indicating the number of collectives to which the individual user K belongs, information indicating the name of each collective, and information related to settings when posting a statement such as a message is displayed. For example, the processor 28 of the terminal device 12K acquires the information indicating the number of collectives and the information indicating the name of each collective from the SNS server 10, and displays the acquired information on the attribute display screen 72.

As the settings when posting a statement such as a message, a setting for the case where a collective is not specified before posting and a setting for the case where a collective is specified before posting are displayed on the attribute display screen 72, for example, and an individual user is able to set these settings on the attribute display screen 72.

In the example illustrated in FIG. 16, the setting for the case where a collective is not specified before posting is set such that the message is posted as a statement by the individual user. In this case, if a collective is not specified before posting, the message is posted as a statement by the individual user. For example, in the case where the individual user K gives an instruction to post a message without specifying a collective, the processor 28 of the terminal device 12K posts the message as a statement by the individual user K.

Also, the setting for the case where a collective is specified before posting is set such that the content of the statement is posted as the content of a statement by the predetermined collective. Specifically, the setting is set such that the content of the statement is posted as the content of a statement by Company β. In this case, if a message is specified as a message to be posted by the collective before posting, the message is posted as a statement by Company β. For example, in the case where the individual user K specifies that a message is to be posted as a statement by a collective, but gives the instruction to post the message without designating a specific collective, the processor 28 of the terminal device 12K posts the message as a statement by Company β.

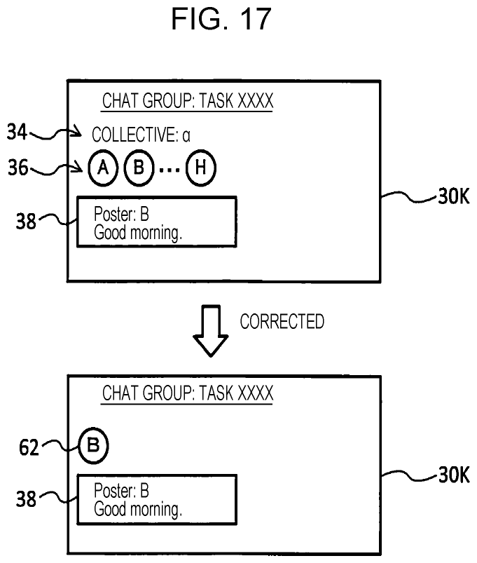

In the case where the content of a statement posted as the content of a statement by a collective is corrected to the content of a statement by an individual user, the processor 28 of the terminal device 12K may cause the content of the statement posted as the content of a statement by the collective to be displayed as the content of a statement by the individual user on the display device of the UI 24 of the terminal device 12K. Hereinafter, this process will be described with reference to FIG. 17. The screen 30K is illustrated in FIG. 17.

For example, assume that the individual user B who belongs to the collective α posts the message 38 as the content of a statement by the collective α. In this case, the message 38 is displayed on the screen 30K as the content of a statement by the collective α. At this point, if the individual user B operates his or her own terminal device 12B to correct the message 38 to the content of a statement by the individual user B, information indicating an instruction for making the correction is transmitted to each terminal device 12 through the SNS server 10. For example, the processor 28 of the terminal device 12K receives the information indicating the instruction for making the correction, and displays the message 38 as the content of a statement by the individual user B on the screen 30K. As illustrated in FIG. 17 for example, after the correction, the processor 28 of the terminal device 12K displays the message 38 in association with the image 62 of the individual user B on the screen 30K. Before the correction, the message 38 had been displayed in association with the collective identification information of the collective α and the images of the individual users who belong to the collective α, but after the correction, only the image of the individual user B is displayed in association with the message 38.

In the case where the above correction is performed by the individual user (for example, the individual user B) who posted the statement (for example, the message 38) to be corrected, the processor 28 of the terminal device 12K may also cause the message 38 posted as a statement by the collective α to be displayed as the content of a statement by the individual user B on the screen 30K. In this case, correction by an individual user other than the individual user B is not allowed. Obviously, correction by a different individual user who has a right to make corrections may also be allowed.

As another example, in the case where the above correction is performed by a different individual user who belongs to the same collective α as the individual user (for example, the individual user B) who posted the statement (for example, the message 38) to be corrected, the processor 28 of the terminal device 12K may cause the message 38 posted as a statement by the collective α to be displayed as the content of a statement by the individual user B on the screen 30K. In this case, a correction by the individual user B does not have to be allowed.

The above correction may be performed by an individual user who has a right to make corrections, whereas an individual user without such a right may be unable to make corrections. For example, in the case where the individual user B has the right to make corrections, the individual user B is allowed to make the above correction. As another example, the above correction may be performed an individual user who belongs to the collective α and has the right to make corrections or by an individual user who does not belong to the collective α but has the right to make corrections, even if the individual user is someone other than the individual user B who posted the message 38.

Also, the message 38 by the collective α may be changed to a message by a different collective. The change may be performed by the individual user B who posted the message 38, by an individual user who belongs to the collective α and has the right to make corrections, or by an individual user who belongs to the different collective.

Furthermore, the message 38 may also be removed. The removal may be performed by the individual user B who posted the message 38 or by an individual user who belongs to the collective α and has a right to remove messages.

Rights enabling an individual user to correct or remove a message as above may also be set. For example, an individual user may be able to correct or remove a message until an individual user who belongs to another collective reads the message, or until a number of individual users equal to or greater than a predetermined number read the message.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Integrated Circuit, FPGA: Field Programmable Gate Array, and programmable logic device). In the exemplary embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to
cause a display device to display a display area for sharing content of a conversation that takes place among a plurality of posters who belong to a chat group, wherein
the plurality of posters include a collective to which a plurality of individual users belong, and
the processor is further configured to
cause the content of a statement by an individual user who belongs to the chat group to be displayed in the display area as the content of a statement by a collective to which the individual user posting the statement belongs.

2. The information processing device according to claim 1, wherein
the processor is further configured to
in a case where a selection is made to post a statement by an individual user as a statement by the individual user, cause the content of the statement by the individual user to be displayed in the display area as the content of a statement by the individual user, and
in a case where a selection is made to post a statement by an individual user as a statement by a collective to which the individual user belongs, cause the content of the statement by the individual user to be displayed in the display area as the content of a statement by the collective.

3. The information processing device according to claim 2, wherein
the processor is further configured to
cause the display device to display a selection screen for selecting whether to post a statement as a statement by an individual user or as a statement by a collective.

4. The information processing device according to claim 1, wherein
the processor is further configured to
in a case where an individual user belongs to a plurality of collectives, cause the content of a statement by the individual user to be displayed in the display area as the content of a statement by a collective selected from among the plurality of collectives.

5. The information processing device according to claim 2, wherein
the processor is further configured to
in a case where an individual user belongs to a plurality of collectives, cause the content of a statement by the individual user to be displayed in the display area as the content of a statement by a collective selected from among the plurality of collectives.

6. The information processing device according to claim 3, wherein
the processor is further configured to
in a case where an individual user belongs to a plurality of collectives, cause the content of a statement by the individual user to be displayed in the display area as the content of a statement by a collective selected from among the plurality of collectives.

7. The information processing device according to claim 1, wherein
the processor is further configured to
cause identification information of a collective and identification information of each individual user who belongs to the collective to be displayed in association with the content of a statement by the collective.

8. The information processing device according to claim 2, wherein
the processor is further configured to
cause identification information of a collective and identification information of each individual user who belongs to the collective to be displayed in association with the content of a statement by the collective.

9. The information processing device according to claim 3, wherein
the processor is further configured to
cause identification information of a collective and identification information of each individual user who belongs to the collective to be displayed in association with the content of a statement by the collective.

10. The information processing device according to claim 7, wherein
the processor is further configured to
cause the identification information of an individual user who has posted a statement as a statement by a collective to be displayed in the display area differently from the identification information of each other individual user who belongs to the collective.

11. The information processing device according to claim 10, wherein
the processor is further configured to
change a display position of the identification information of an individual user who has posted a statement as a statement by a collective from the display position of the identification information of the individual user in a case where the individual user has not posted the statement as a statement by the collective.

12. The information processing device according to claim 7, wherein
the processor is further configured to
in a case where an operation of associating the identification information of an individual user with a collective to which the individual user does not belong is performed in the display area, cause the individual user subjected to the operation to belong to the collective subjected to the operation.

13. The information processing device according to claim 7, wherein
the processor is further configured to
in a case where an operation of moving the identification information of an individual user from a display position of the identification information of the individual user to another position is performed in the display area, exclude the individual user subjected to the operation from the collective to which the individual user belongs.

14. The information processing device according to claim 1, wherein
the processor is further configured to
cause identification information of an individual user who has posted a statement as a statement by a collective to be displayed in an area where the content of the statement is displayed.

15. The information processing device according to claim 1, wherein
the processor is further configured to
in a case where a collective is not specified before posting a statement, cause the content of the statement to be displayed in the display area as the content of a statement by an individual user.

16. The information processing device according to claim 1, wherein
the processor is further configured to
in a case where a statement is specified to be posted as a statement by a collective before posting the statement, cause the content of the statement to be displayed in the display area as the content of a statement by a predetermined collective.

17. The information processing device according to claim 1, wherein
the processor is further configured to
in a case where the content of a statement posted as the content of a statement by a collective is corrected to the content of a statement by an individual user, cause the content of the statement posted as the content of a statement by the collective to be displayed in the display area as the content of a statement by the individual user.

18. The information processing device according to claim 17, wherein
the processor is further configured to
in a case where the correction is performed by the individual user who posted the statement, cause the content of the statement posted as the content of a statement by the collective to be displayed in the display area as the content of a statement by the individual user.

19. The information processing device according to claim 17, wherein
the processor is further configured to
in a case where the correction is performed by a different individual user who belongs to the same collective as the individual user who posted the statement, cause the content of the statement posted as the content of a statement by the collective to be displayed in the display area as the content of a statement by the individual user.

20. A non-transitory computer readable medium storing a program causing a computer to execute a process for processing information, the computer being used in a conversation that takes place among a plurality of posters including a collective to which a plurality of individual users belong, the process comprising:
causing a display device to display a display area for sharing content of the conversation that takes place among the plurality of posters who belong to a chat group, and
causing the content of a statement by an individual user who belongs to the chat group to be displayed in the display area as the content of a statement by a collective to which the individual user posting the statement belongs.
